(19) United States
(12) Patent Application Publication
(10) Pub. No.: US 2014/0071362 A1
(43) Pub. Date: Mar. 13, 2014

(54) LIQUID CRYSTAL DISPLAY PANEL

(71) Applicant: Polin Chen, Shenzhen (CN)

(72) Inventor: Polin Chen, Shenzhen (CN)

(73) Assignee: SHENZHEN CHINA STAR OPTOELECTRONICS TECHNOLOGY CO., LTD., Shenzhen, Guangdong, (CN)

(21) Appl. No.: 13/698,079

(22) PCT Filed: Sep. 14, 2012
(86) PCT No.: PCT/CN2012/081369

§ 371 Date: Nov. 15, 2012

(30) Foreign Application Priority Data
Sep. 7, 2012 (CN) 201210330040.3

(51) Int. Cl. G02F 1/1368

(52) U.S. Cl. CPC G02F 1/1368
USPC 349/43

(57) ABSTRACT

The present invention provides a liquid crystal display panel including a TFT substrate and a CF substrate laminated on the TFT substrate. The TFT substrate forms first TFTs and second TFTs. The first TFTs are symmetric TFTs, which form a first channel. The second TFTs are non-symmetric TFTs, which form a second channel. The first channel has a length greater than length of the second channel by 0.2-0.4 μm, so that in a masking operation, the thicknesses of the half-tone photoresist materials that are used to form the channels can be made approximate to each other thereby eliminating the potential risk of array yield loss found in the prior art techniques due to thickness difference of half-tone photoresist materials used to form the channel of the symmetric TFTs and the channel of the non-symmetric TFTs, effectively improving array yield strength, and thus enhancing the quality of the liquid crystal display panel.

### BACKGROUND OF THE INVENTION

1. Field of the Invention

The present invention relates to the field of liquid crystal displaying, and in particular to a liquid crystal display panel.

2. The Related Arts

Liquid crystal display (LCD) has a variety of advantages, such as thin device body, low power consumption, and being free of radiation, and is thus widely used. Most of the LCDs that are currently available in the market are backlighting LCDs, which comprise a liquid crystal display panel and a backlight module. The operation principle of the liquid crystal display panel is that liquid crystal molecules are interposed between two parallel glass substrates and electricity is applied to the glass substrates to control variation of orientation of the liquid crystal molecules in order to refract light emitting from the backlight module for generating images.

A liquid crystal display panel is generally composed of a color filter substrate, a thin film transistor (TFT) substrate, and liquid crystal (LC) and sealant interposed between the CF substrate and the TFT substrate. A general manufacturing process comprises a front stage of array process (including thin film, yellow light, etching, and film stripping), an intermediate stage of cell process (including bonding TFT substrate and the CF substrate), and a rear stage of assembling process (including mounting drive ICs and printed circuit board). The front stage of array process generally makes the TFT substrate for controlling the movement of liquid crystal molecules. The intermediate stage of cell process generally introduces the liquid crystal between the TFT substrate and the CF substrate. The rear stage of assembling process generally integrates the drive ICs and the printed circuit board to drive the liquid crystal molecules to rotate for displaying images.

Referring to FIGS. 1A-1E, structures of a TFT substrate manufactured at different steps of a conventional process applying five masking operations are schematically shown. A gate terminal 101 is first formed on a glass substrate 100. A gate insulation layer 103 is then formed on the gate terminal 101 and a semiconductor layer 105 is formed on the gate insulation layer 103. A source terminal 107 and a drain terminal 109 are then formed on the semiconductor layer 105. Afterwards, an insulation layer 110, a channel 113, and an indium tin oxides (ITO) layer 115 are formed to complete the manufacture of the TFT substrate.

To lower down the manufacture cost, technicians of the field further simplify the TFT substrate manufacture process. Reference is now made to FIGS. 2A-2D, which are schematic views showing the structures of a TFT substrate manufactured at different steps of a conventional process applying four masking operations. A metal layer 310 is first etched and then dry etching is applied to a photoresist layer 330. Afterwards, a channel is formed in the metal layer through etching. Finally, dry etching is applied to remove a portion of a nitrogen doped hydrogenated amorphous silicon (n+a-Si:H) layer 350 to further form the channel. In this process, controlling the thickness of half-tone photoresist is key factor of process stability. If the half-tone photoresist layer is excessively thin, the size abnormality and channel dirt of the channel may result. If the half-tone photoresist layer is excessively thick, then channel short of the channel 113″ may result.

Referring to FIG. 3, in a commonly used TFT substrate, each individual sub-pixel comprises a symmetric TFT 500 and a non-symmetric TFT 700. When the above discussed process that applies four masking operations is used to manufacture a TFT substrate, the half-tone photoresist used for the symmetric TFT 500 is generally thicker than the half-tone photoresist for non-symmetric TFT 700. This easily leads to array yield loss.

### SUMMARY OF THE INVENTION

An object of the present invention is to provide a liquid crystal display panel, which effectively address the issue of excessive thickness difference of half-tone photoresist material between a symmetric thin-film transistor and a non-symmetric thin-film transistor so as to improve array yield.

To achieve the object, the present invention provides a liquid crystal display panel, which comprises: a TFT substrate and a CF substrate laminated on the TFT substrate. The TFT substrate forming a plurality of first thin-film transistors and a plurality of second thin-film transistors. The first thin-film transistors are symmetric thin-film transistors, which form a first channel. The second thin-film transistors are non-symmetric thin-film transistors, which form a second channel. The first channel has a length that is greater than length of the second channel by 0.2-0.4 μm.

The length of the first channel is greater than the length of the second channel by 0.3 μm.

The length of the first channel is 2.7-4.9 μm.

The length of the second channel is 2.5-4.5 μm.

The liquid crystal display panel further comprises liquid crystal and a sealant frame arranged between the TFT substrate and the CF substrate.

The liquid crystal display panel further comprises a bottom polarizer laminated on a surface of the TFT substrate that is distant from the CF substrate and a top polarizer laminated on a surface of the CF substrate that is distant from the TFT substrate.

The liquid crystal display panel further comprises a first alignment film laminated on a surface of the TFT substrate that is close to the CF substrate and a second alignment film laminated on a surface of the CF substrate that is close to the TFT substrate.

The TFT substrate comprises a first glass substrate. The first and second thin-film transistors are formed through a masking operation on the first glass substrate.

The CF substrate comprises a second glass substrate and a plurality of pixel units formed on the second glass substrate. Each of the pixel units comprises a plurality of the sub-pixels. Each of the sub-pixels corresponds to one of the first thin-film transistors and one of the second thin-film transistors.

The present invention also provides a liquid crystal display panel, which comprises: a TFT substrate and a CF substrate laminated on the TFT substrate, the TFT substrate forming a plurality of first thin-film transistors and a plurality of second thin-film transistors, the first thin-film transistors being symmetric thin-film transistors, which form a first channel, the second thin-film transistors being non-symmetric thin-film transistors, which form a second channel, the first channel having a length that is greater than length of the second channel by 0.2-0.4 μm;

wherein the length of the first channel is greater than the length of the second channel by 0.3 μm;

wherein the length of the first channel is 2.7-4.9 μm;

wherein the length of the second channel is 2.5-4.5 μm;

further comprising liquid crystal and a sealant frame arranged between the TFT substrate and the CF substrate;

further comprising a bottom polarizer laminated on a surface of the TFT substrate that is distant from the CF substrate and a top polarizer laminated on a surface of the CF substrate that is distant from the TFT substrate;

further comprising a first alignment film laminated on a surface of the TFT substrate that is close to the CF substrate and a second alignment film laminated on a surface of the CF substrate that is close to the TFT substrate;

wherein the TFT substrate comprise a first glass substrate, the first and second thin-film transistors being formed through a masking operation on the first glass substrate; and

wherein the CF substrate comprise a second glass substrate and a plurality of pixel units formed on the second glass substrate, each of the pixel units comprising a plurality of the sub-pixels, each of the sub-pixels corresponding to one of the first thin-film transistors and one of the second thin-film transistors.

The efficacy of the present invention is that the present invention provides a liquid crystal display panel, which makes the length of a channel of a symmetric thin-film transistor greater than the length of a channel of a non-symmetric thin-film transistor by 0.3 μm by adjusting the channel lengths of the symmetric thin-film transistor and the non-symmetric thin-film transistor, so that in a masking operation, the thicknesses of the half-tone photoresist materials that are used to form the channels can be made approximate to each other thereby eliminating the potential risk of array yield loss found in the prior art techniques due to thickness difference of half-tone photoresist materials used to form the channel of the symmetric thin-film transistors and the channel of the non-symmetric thin-film transistors, effectively improving array yield strength, and thus enhancing the quality of the liquid crystal display panel.

For better understanding of the features and technical contents of the present invention, reference will be made to the following detailed description of the present invention and the attached drawings. However, the drawings are provided for the purposes of reference and illustration and are not intended to impose undue limitations to the present invention.

### BRIEF DESCRIPTION OF THE DRAWINGS

The technical solution, as well as beneficial advantages, will be apparent from the following detailed description of an embodiment of the present invention, with reference to the attached drawings. In the drawings:

FIGS. 1A-1E are schematic views showing structures of a TFT substrate manufactured at different steps of a conventional process applying five masking operations;

FIGS. 2A-2D are schematic views showing structures of a TFT substrate manufactured at different steps of a conventional process applying four masking operations;

FIG. 3 is a schematic view showing a single pixel of a TFT substrate of a conventional liquid crystal display panel; and

FIG. 4 is a schematic view showing a liquid crystal display panel according to the present invention.

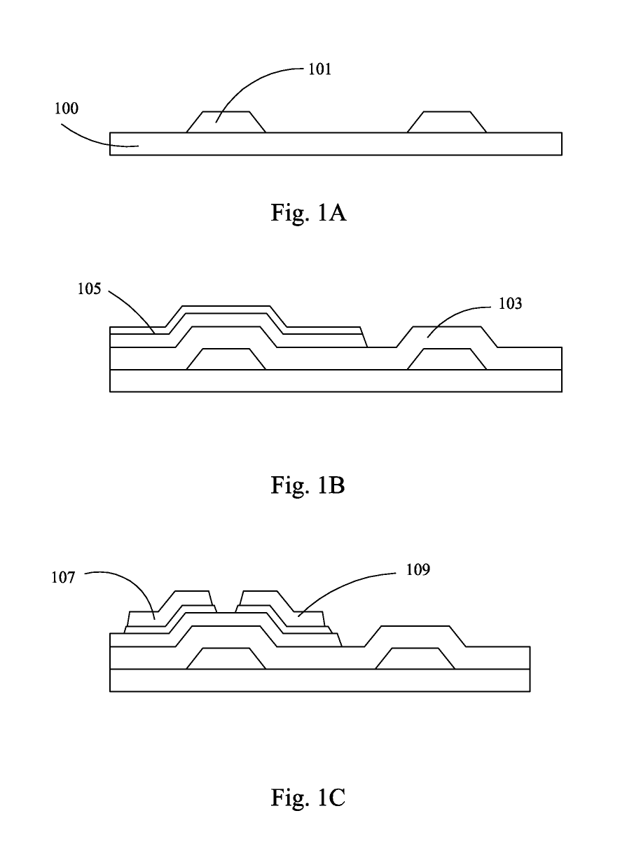

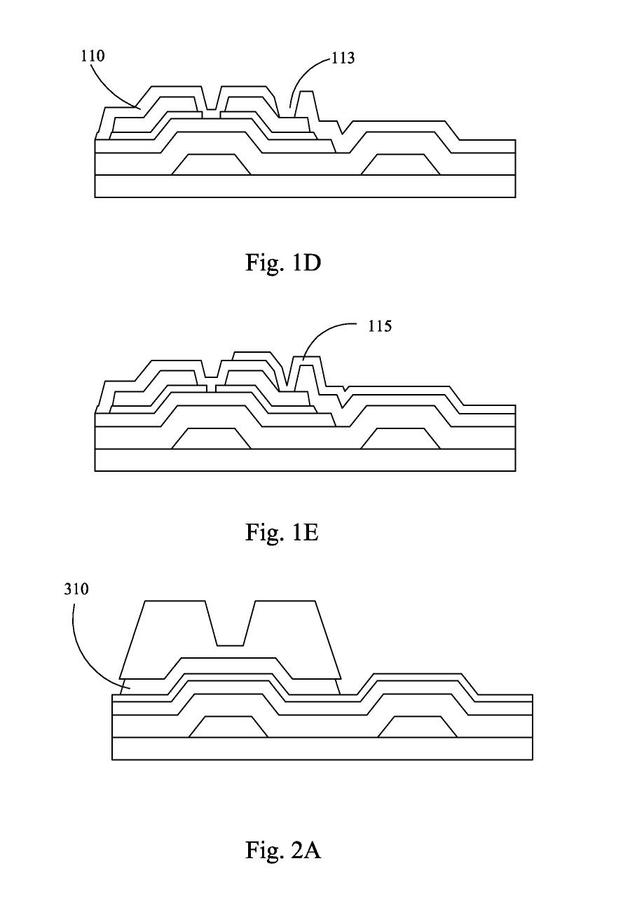

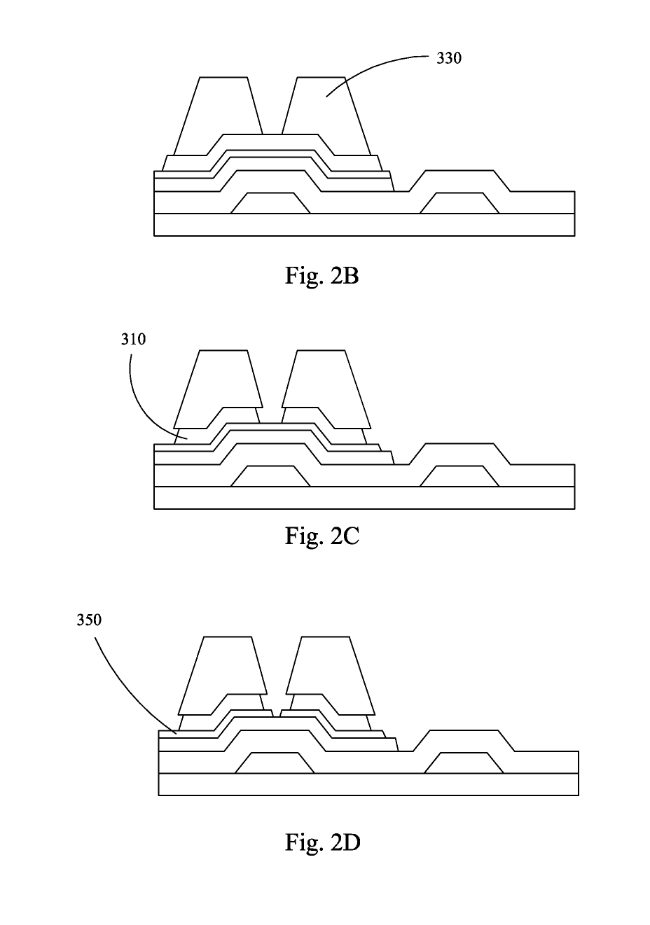

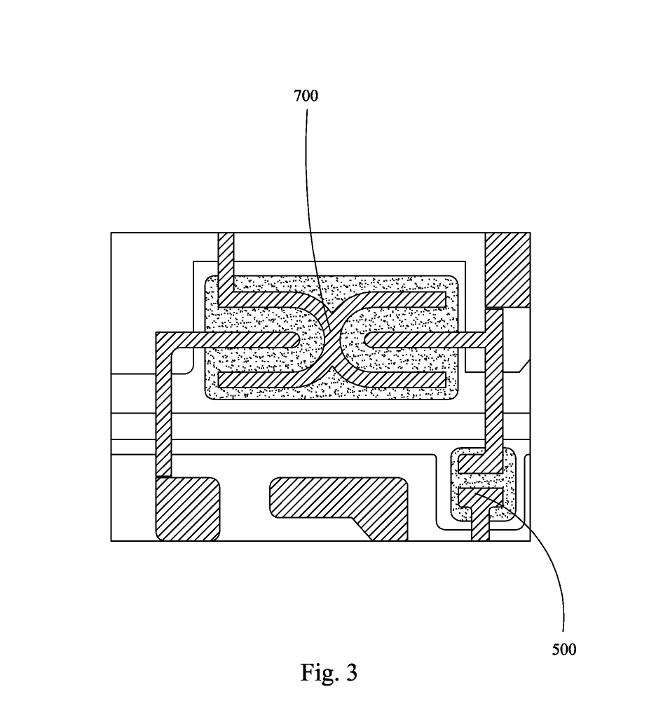

### DETAILED DESCRIPTION OF THE PREFERRED EMBODIMENTS

To further expound the technical solution adopted in the present invention and the advantages thereof, a detailed description is given to a preferred embodiment of the present invention and the attached drawings.

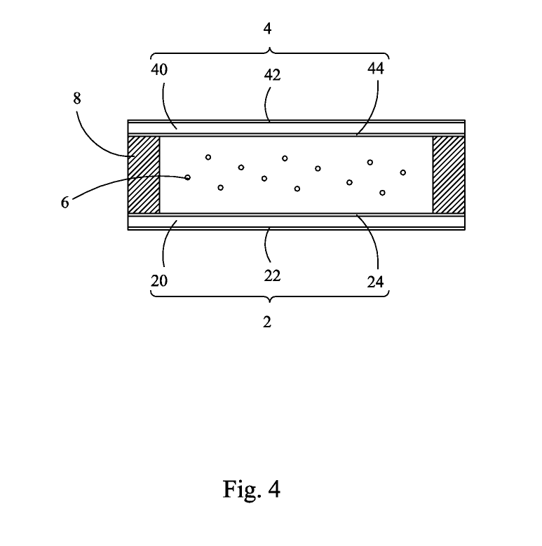

Referring to FIG. 4, the present invention provides a liquid crystal display panel, which comprises: a TFT substrate 2 and a CF substrate 4 laminated on the TFT substrate 2.

The TFT substrate 2 forms a plurality of first thin-film transistors (not shown) and a plurality of second thin-film transistors (not shown). The first thin-film transistors are symmetric thin-film transistors, which form a first channel. The second thin-film transistors are non-symmetric thin-film transistors, which form a second channel. The first channel has a length that is 0.2-0.4 μm longer than length of the second channel. Preferably, the length of first channel is greater than that of the second channel by 0.3 μm.

In the instant embodiment, the length of the first channel is 2.7-4.9μ and the length of the second channel is 2.5-4.5 μm.

The channel length of a regular non-symmetric thin-film transistor is around 3.5 μm after the manufacture thereof is completed and the thickness of half-tone photoresist material thereof is around 6000 Å in the forgoing masking operation. However, for a symmetric thin-film transistor that also has a channel length of 3.5 μm after completion of manufacture, the thickness of the half-tone photoresist material is around 8000 Å in the forgoing masking operation, this being thicker than the thickness of half-tone photoresist material for a non-symmetric thin-film transistor by around 2000 Å.

For a symmetric thin-film transistor that has a channel length of around 3.8 μm after completion of manufacture, the thickness of half-tone photoresist material thereof in the forgoing masking operation is around 6000 Å. Under this condition, the thickness of half-tone photoresist material for forming the channel of a symmetric thin-film transistor is approximate to the thickness of half-tone photoresist material for forming the channel of a non-symmetric thin-film transistor and this helps widening the process window and facilitates increasing array yield.

The liquid crystal display panel according to the present invention also comprises liquid crystal 6 and a sealant frame 8 arranged between the TFT substrate 2 and the CF substrate 4. The sealant frame 8 is set along edges of the TFT substrate 2 and the CF substrate 4 to bond the TFT substrate 2 and the CF substrate 4 together and encloses the liquid crystal 6 between the TFT substrate 2 and the CF substrate 4.

The TFT substrate 2 comprises a first glass substrate 20. The first and second thin-film transistors are formed through a masking operation on the first glass substrate 20.

The CF substrate 4 comprises a second glass substrate 40 and a plurality of the pixel units (not shown) formed on the second glass substrate 40. Each of the pixel units comprises a plurality of sub-pixels. Each of the sub-pixels corresponds to one first thin-film transistor and one second thin-film transistor.

The liquid crystal display panel according to the present invention also comprises a bottom polarizer 22 laminated on a surface of the TFT substrate 2 that is distant from the CF substrate 4 and a top polarizer 42 laminated on a surface of the CF substrate 4 that is distant from the TFT substrate 2.

The liquid crystal display panel according to the present invention also comprises a first alignment film 24 laminated on a surface of the TFT substrate 2 that is close to the CF substrate 4 and a second alignment film 44 laminated on a surface of the CF substrate 4 that is close to the TFT substrate 2.

The present invention provides a liquid crystal display panel, which makes the length of a channel of a symmetric thin-film transistor greater than the length of a channel of a non-symmetric thin-film transistor by 0.3 μm by adjusting the channel lengths of the symmetric thin-film transistor and the non-symmetric thin-film transistor, so that in a masking operation, the thicknesses of the half-tone photoresist materials that are used to form the channels can be made approximate to each other thereby eliminating the potential risk of array yield loss found in the prior art techniques due to thickness difference of half-tone photoresist materials used to form the channel of the symmetric thin-film transistors and the channel of the non-symmetric thin-film transistors, effectively improving array yield strength, and thus enhancing the quality of the liquid crystal display panel.

Based on the description given above, those having ordinary skills of the art may easily contemplate various changes and modifications of the technical solution and technical ideas of the present invention and all these changes and modifications are considered within the protection scope of right for the present invention.

What is claimed is:

1. A liquid crystal display panel, comprising: a TFT substrate and a CF substrate laminated on the TFT substrate, the TFT substrate forming a plurality of first thin-film transistors and a plurality of second thin-film transistors, the first thin-film transistors being symmetric thin-film transistors, which form a first channel, the second thin-film transistors being non-symmetric thin-film transistors, which form a second channel, the first channel having a length that is greater than length of the second channel by 0.2-0.4 μm.

2. The liquid crystal display panel as claimed in claim 1, wherein the length of the first channel is greater than the length of the second channel by 0.3 μm.

3. The liquid crystal display panel as claimed in claim 1, wherein the length of the first channel is 2.7-4.9 μm.

4. The liquid crystal display panel as claimed in claim 1, wherein the length of the second channel is 2.5-4.5 μm.

5. The liquid crystal display panel as claimed in claim 1 further comprising liquid crystal and a sealant frame arranged between the TFT substrate and the CF substrate.

6. The liquid crystal display panel as claimed in claim 1 further comprising a bottom polarizer laminated on a surface of the TFT substrate that is distant from the CF substrate and a top polarizer laminated on a surface of the CF substrate that is distant from the TFT substrate.

7. The liquid crystal display panel as claimed in claim 1 further comprising a first alignment film laminated on a surface of the TFT substrate that is close to the CF substrate and a second alignment film laminated on a surface of the CF substrate that is close to the TFT substrate.

8. The liquid crystal display panel as claimed in claim 1, wherein the TFT substrate comprises a first glass substrate, the first and second thin-film transistors being formed through a masking operation on the first glass substrate.

9. The liquid crystal display panel as claimed in claim 1, wherein the CF substrate comprises a second glass substrate and a plurality of pixel units formed on the second glass substrate, each of the pixel units comprising a plurality of the sub-pixels, each of the sub-pixels corresponding to one of the first thin-film transistors and one of the second thin-film transistors.

10. A liquid crystal display panel, comprising: a TFT substrate and a CF substrate laminated on the TFT substrate, the TFT substrate forming a plurality of first thin-film transistors and a plurality of second thin-film transistors, the first thin-film transistors being symmetric thin-film transistors, which form a first channel, the second thin-film transistors being non-symmetric thin-film transistors, which form a second channel, the first channel having a length that is greater than length of the second channel by 0.2-0.4 μm;
wherein the length of the first channel is greater than the length of the second channel by 0.3 μm;
wherein the length of the first channel is 2.7-4.9 μm;
wherein the length of the second channel is 2.5-4.5 μm;
further comprising liquid crystal and a sealant frame arranged between the TFT substrate and the CF substrate;
further comprising a bottom polarizer laminated on a surface of the TFT substrate that is distant from the CF substrate and a top polarizer laminated on a surface of the CF substrate that is distant from the TFT substrate;
further comprising a first alignment film laminated on a surface of the TFT substrate that is close to the CF substrate and a second alignment film laminated on a surface of the CF substrate that is close to the TFT substrate;
wherein the TFT substrate comprises a first glass substrate, the first and second thin-film transistors being formed through a masking operation on the first glass substrate; and
wherein the CF substrate comprises a second glass substrate and a plurality of pixel units formed on the second glass substrate, each of the pixel units comprising a plurality of the sub-pixels, each of the sub-pixels corresponding to one of the first thin-film transistors and one of the second thin-film transistors.
